(19) United States
(12) Patent Application Publication
(10) Pub. No.: US 2026/0092577 A1
(43) Pub. Date: Apr. 2, 2026

(54) Near-Adiabatic External Heat Valve Engine

(71) Applicant: Barry W. JOHNSTON, Baltimore, MD (US)

(72) Inventor: Barry W. JOHNSTON, Baltimore, MD (US)

(21) Appl. No.: 18/902,438

(22) Filed: Sep. 30, 2024

Related U.S. Application Data
(60) Provisional application No. 63/541,332, filed on Sep. 29, 2023.

(51) Int. Cl. F02G 1/055

(52) U.S. Cl. CPC F02G 1/055

(57) ABSTRACT

In a process, an inlet valve is opens from a hot plenum, and injects a working volume with hot fluid, and then closes. The hot fluid expands as a piston moves down. As the piston approaches the BDC, uniflow ports at a bottom uncover, and timed valves at a top open, flooding the fluid with cooled pressurized fluid from a cold plenum, and supercooling the expanded fluid into the working chamber where the fluid was prepared and cooled during a previous cycle. The working fluid is compressed back into the cold plenum, wherein heat is removed, and the timed valves close. The fluid remaining in the working volume is compressed into a remaining upstroke volume before being pressed into the hot plenum. The compressed fluid in the working volume is displaced by the piston motion through a one-way exhaust reed valve to the hot plenum, where it is reheated.

### BRIEF DESCRIPTION OF THE DRAWINGS

The described embodiments are illustrated by way of example, and not by limitation, in the figures of the accompanying drawings, wherein elements having the same reference numeral designations represent like elements throughout, unless otherwise specified.

FIG. 1 provides backup analysis of the near-adiabatic cycle as described on page 9.

FIG. 2 provides backup performance analysis of the near-adiabatic engine as described on pages 9 and 10. FIG. 2a shows the hyperbolic principle applied to the expansion and compression forces of the cycle.

FIG. 3 compares Stirling engines with the disclosed near-adiabatic engine, explaining why the disclosed near-adiabatic cycle optimizes heat utilization and conversion into work output.

FIG. 4 shows the component layout of the single cylinder configuration.

FIG. 5 shows the operation of the cellonoid inlet poppet valves as they relate to the function surrounding the working chamber.

FIG. 6 shows the cold plenum's design, including the coolant compartment's configuration.

FIG. 7 shows the operation of the pump valve between the working chamber and hot plenum.

FIG. 8 shows the operation of the dual cam mechanism actuating the opening of the poppet valves and the connect valves between the cold plenum and working chamber.

FIG. 9 is a cross-sectional view of the working chamber, cold plenum, and associated valves.

FIG. 10 is a schematic diagram showing the pneumatic and mechanical operation of the proposed cycle.

FIG. 11 is a schematic diagram showing further refinement of the pneumatic and mechanical operation of the proposed cycle.

FIG. 12 shows the operation of the exhaust and inflow of the bolus and volume closing, fixing the bolus volume.

FIG. 13 shows steps 2, 3, and 4, opening the connection valve between the cold plenum and working chamber.

FIG. 14 show step 6, the pumping process, cycling the working fluid back into the hot plenum for reheating.

FIG. 15 shows the closing action, fixing the volume after the bolus injection.

FIG. 16 explains the force interphase between the downstroke force/work as balanced against the distributor input force/work during the upstroke to produce a net work output.

FIG. 17 shows the alternator electronic diagram as actuating the engine upstroke.

FIG. 18 shows the configuration of the linear two-cylinder radioisotope EHVE based on the force balance between the pneumatic and distributor forces.

FIG. 19 is a detailed drawing of step 1, the bolus injection into the engine.

FIG. 20 shows the closing action, fixing the volume after the bolus injection.

FIG. 21 is a detailed drawing of step 2, the downstroke expansion in the working chamber.

FIG. 22 is a detailed drawing of step 3, showing the supercooling occurring with the opening of the connection valves between the cold plenum and working chamber.

FIG. 23 is a detailed drawing of step 4, showing the upstroke heat scavenging process occurring in the cold plenum and working chamber.

FIG. 24 is a detailed drawing of step 5, showing the equivalent adiabatic compression upstroke of the cycle.

FIG. 25 is a detailed drawing of step 6, showing the pumping process back into the hot plenum.

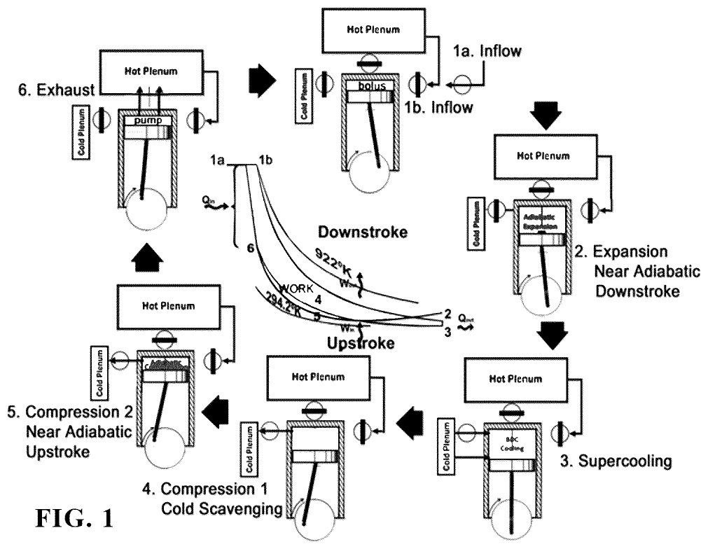

### 1. GENERAL DESCRIPTION OF THE SIX STEPS OF THE CYCLE

The Johnston Engine is a closed-cycle externally heated valve engine (EHVE), defined in six stages.
Stage 1—Inflow. The inlet valve opens (1a) from the Hot Plenum, and injects the working volume (bolus) with hot high-temperature/pressure working fluid, and then closes (1b).
Stage 2—Expansion. The hot fluid expands as the piston moves down until it reaches Bottom Dead Center (BDC).
Stage 3—Cold Scavenge. Approaching BDC, uniflow ports (bottom) uncover, and timed valves (near the top) open, flooding the working fluid with cooled pressurized fluid from the cold plenum, supercooling the expanded fluid into the working chamber. This fluid was prepared and cooled during the previous cycle.
Stage 4—Compression 1. The working volume fluid is compressed back into the cold plenum, where heat is removed. Once recompressed, timed valves close between the working volume and cold plenum.
Stage 5—Compression 2. Fluid remaining in the working volume is compressed into the remaining upstroke volume before being pressed into the hot plenum. (Note: the density ratio between the working volume and cold plenum governs the proportioning between Compression 1 and 2.)
Stage 6—Exhaust. The compressed fluid in the working volume is displaced by the piston motion through a one-way exhaust reed valve to the hot plenum, where it is reheated.

### The Engine Design

The near adiabatic downstroke of the Johnston engine is straightforward. The upstroke is the challenge. During the upstroke, a mass is pressed into the cooling exchanger (cold plenum). Heat is removed during that compression and, also, when that compressed mass is encapsulated (isolated) in the cold plenum. That heat removal is then released back into the working chamber at the BDC mixing. An adiabatic cycle is created because the negative work of the upstroke assimilates an ideal adiabatic upstroke. At the point of release, pressure goes up while the temperature goes down. Since the volume change (ΔV of the W=pΔV compression stroke) is the same whether adiabatic or otherwise, and since the pressure begins higher than before the release, the pressure of the real upstroke (equal in both the working chamber and cold plenum volume) is altered by the heat absorption, resulting in the pressure being altered so to match that of the ideal adiabatic upstroke. This means the end temperature at the high endpoint of the compression upstroke has the same temperature and internal energy as if adiabatically compressed and that that upstroke work is equivalent to an adiabatic upstroke. In the design of the engine, the upstroke compression in the working chamber (which is interact with both the work chamber and cold plenum volume) must be equivalent to the conditions of an ideal adiabatic compression upstroke. During the upstroke, heat is removed from the mass that is unidirectionally pressed into the cool plenum, though the pressure in both the working chamber and the cold plenum is the same. Unidirectional means that no heat is removed from the working fluid mass remaining in the working chamber. Thus, although heat is removed by the cold plenum, the pressure is adjusted so that it is progressively equivalent to the ideal pressure of an adiabatic upstroke. The work output is W_{downstroke}−Wᵤₚₛₜᵣₒₖₑ=ΔW. Heat removal is

U_{downstroke}−Uᵤₚₛₜᵣₒₖₑ=ΔU.

The internal energy difference AU is the released heat removal at BDC. Optimum efficiency means ΔW=ΔU. Since the conservation of energy formula is

W=U−Q,

i.e.,

pΔV=mRT−mCvΔT,

each property (T₁, T₂, m₁, m₂, V₁, V₂, and p) is defined by inversions within the basic

W=U−Q

formula.

Let's look at how the adiabatic cycle occurs while the heat is being removed. In the adiabatic formula, the upstroke and downstroke volume changes are the same, and the R and Cv factors are constants. The mass changes in the working chamber and the cold plenum depend on the amount of heat absorption in the cooling exchanger, i.e.,

pΔV=U−Q.

The upstroke U is the internal energy in the system after the BDC mixing. Q is the amount of heat removed during the upstroke,

Q=mΔTCv=m(T₁−T₂)Cv,

and the rest of the cycle. We know that, at the BDC mixing, the mass in the working chamber is proportional to the relative volumes of the cooling exchanger and working chamber since the density in both is initially the same. In determining and regulating the pressures and temperatures during the upstroke, knowing the negative work (pΔV) of our engine must equal the sum effect of a pure adiabatic upstroke, the endpoint of the compressed working fluid must have the same temperature and pressure as an ideal adiabatic upstroke. To be near adiabatic, the heat absorption must render the same mean pressure condition as the ideal adiabatic. In our prototype, at the BDC mixing, the pressure rises from 0.5557 Mpa to ^{˜}0.6893 Mpa, while the temperature drops from 399.5° K to ^{˜}298.2° K. Since we can predict the above, we can correlate the relationship of the pressure (p) to temperatures (T₁ and T₂) in the working chamber and cold plenum to assimilate a near adiabatic condition. Beginning at 298.15° K, heat removal occurs in the mass that unidirectionally flows into the cold plenum.

After the cold plenum closes, under the pressurized condition caused by the upstroke, further heat is removed. All heat removal occurs before the pressurized fluid is released back into the working chamber at the BDC, before beginning the next upstroke. The heat removed in the cold plenum can only approach the brine temperature (289.817° K using water or 253.71° K using a refrigerant). When the captured higher-pressure level is released at BDC into the much lower pressure (0.55572 Mpa) in the working chamber, the pressure will rise to a common level of ^{˜}0.689476 Mpa. Although the pressure rises, the temperature drops to a level above the cold plenum temperature, ^{˜}289.817° K, so that the flow during the next compression upstroke from the working chamber to the cooling exchanger is unidirectional. To determine through Matlab analysis and testing the “sweet spot” providing optimum efficiency, various internal parameters can be regulated through sizing, using the following three methods: 1) by varying the surface area of the plates and volume size of the heat exchanger, (Various interchangeable sizes of heat exchangers can be mounted on our prototype, allowing adjustment of the plate and volume sizes), 2) Varying the temperature of the brine fluid (water), and 3) by varying the rate of flow of the brine coolant.

### The Approach

### Optimizing Heat Removal

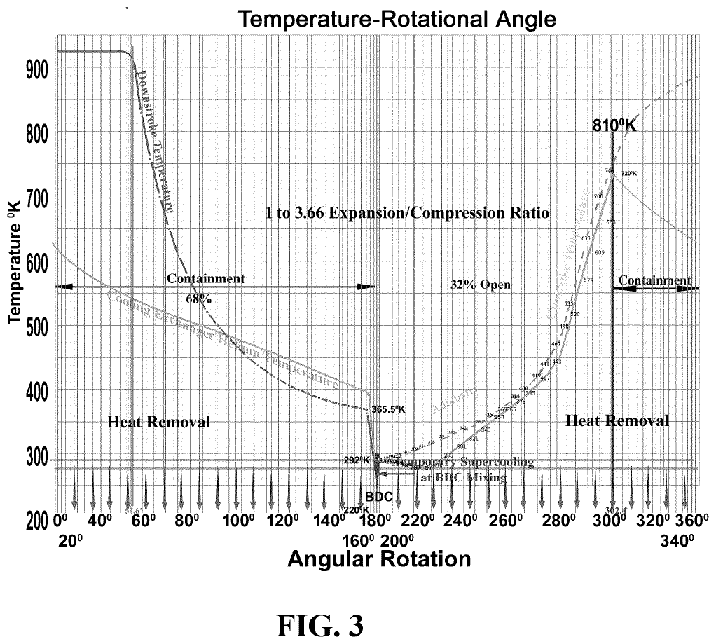

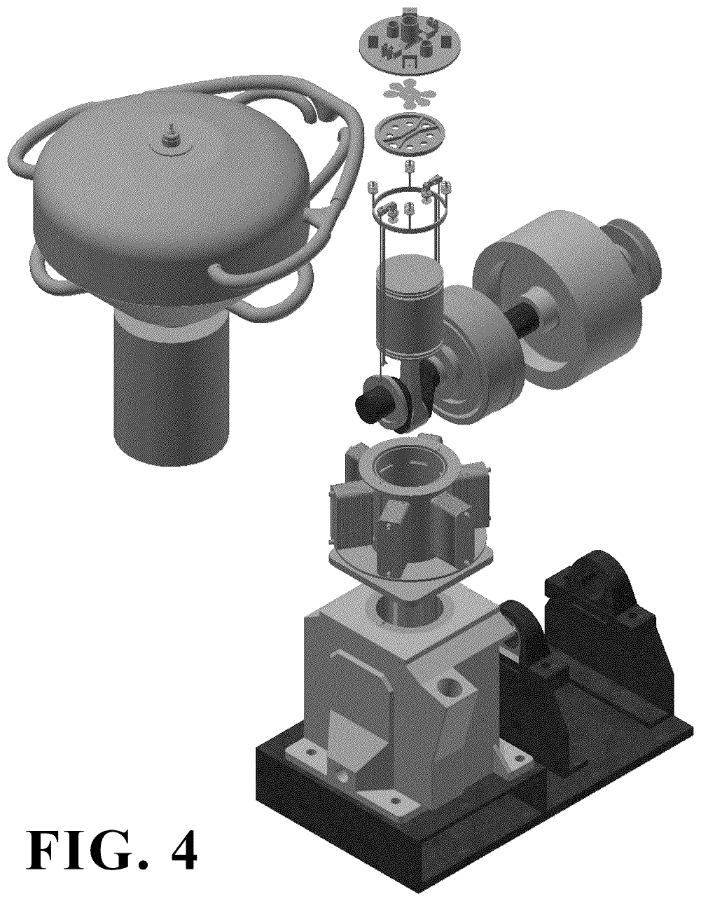

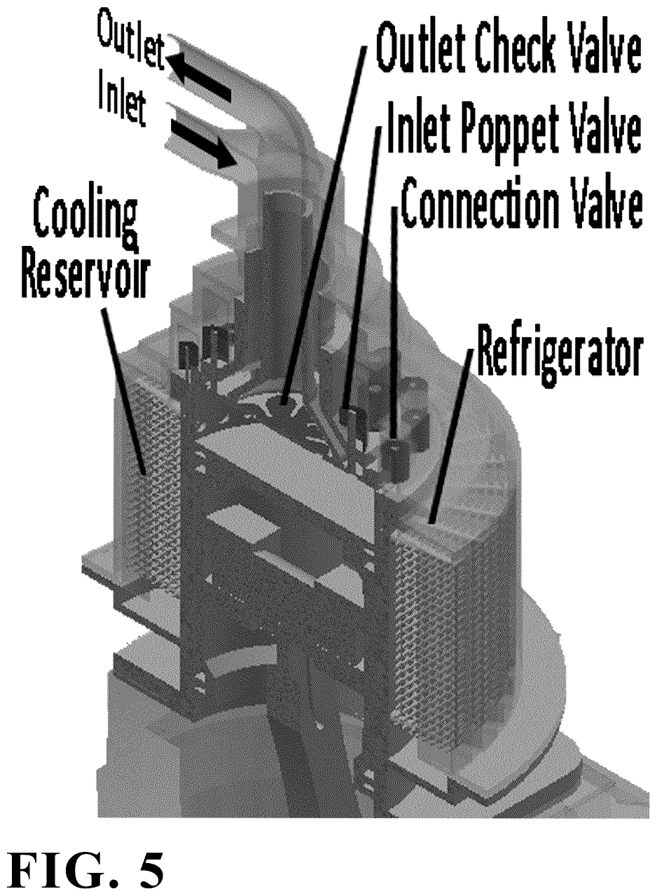

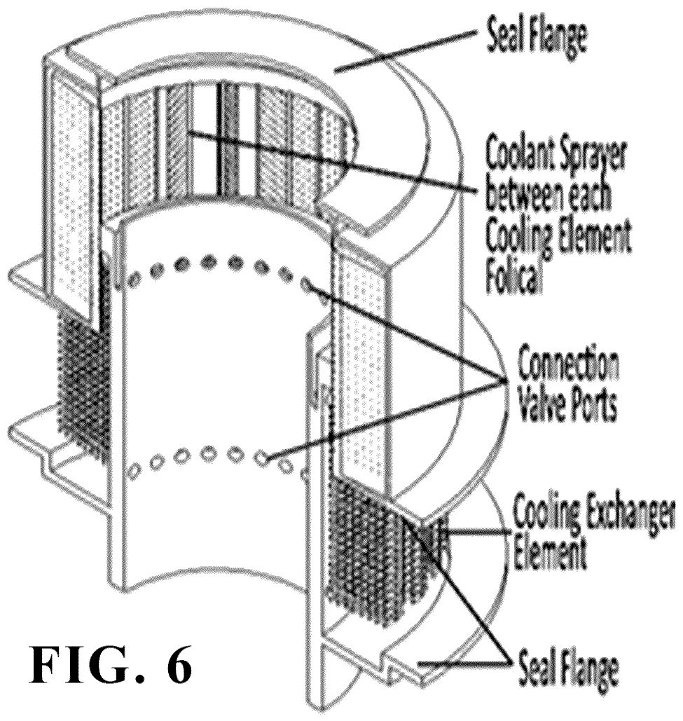

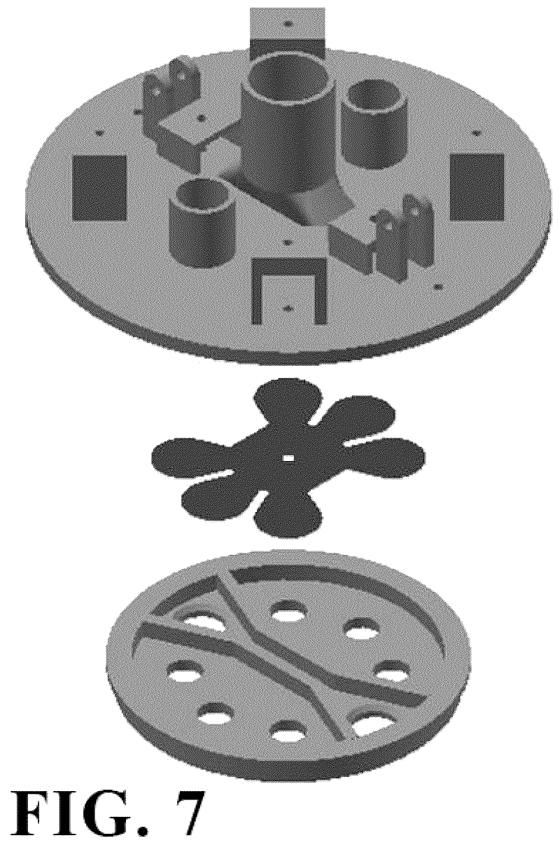

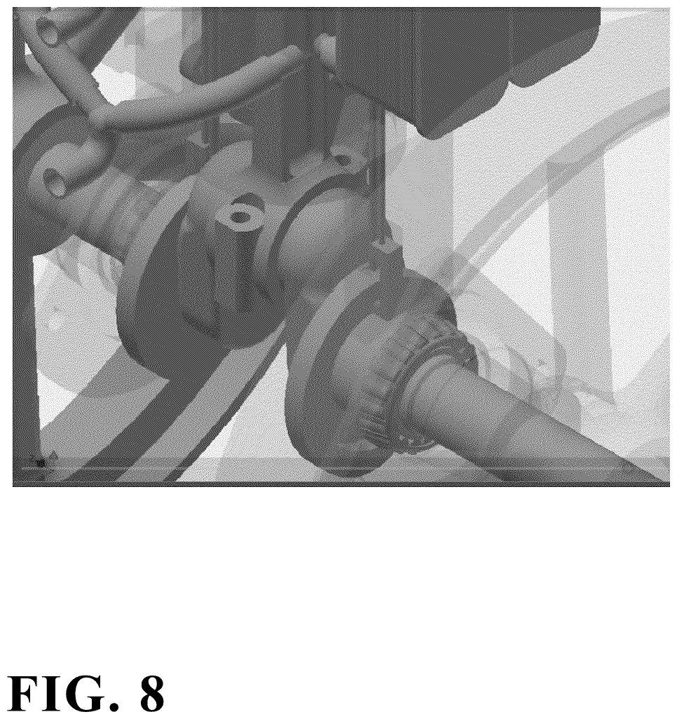

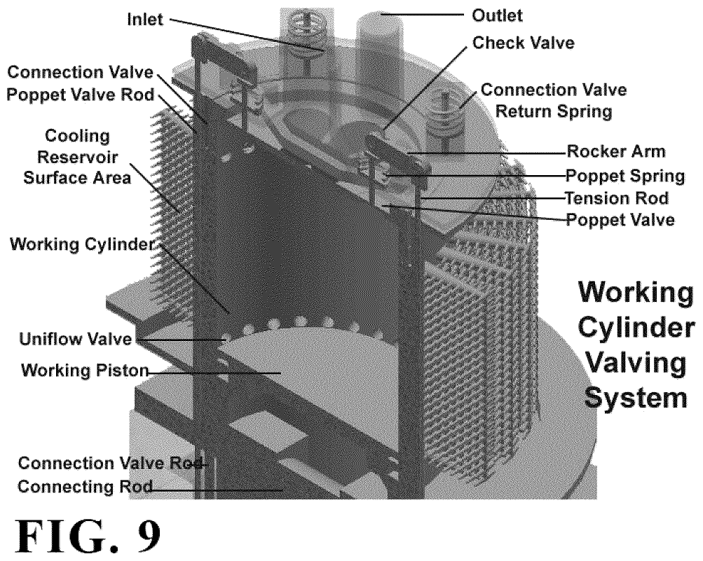

No heat is extracted from the Johnston EHVE except through the cooling plenum isothermal cooling, ΔQ_{cold plenum}, and no heat is added except through isothermal heating in the hot plenum, ΔQ_{hot plenum}. Because of the near-ideal adiabatic condition, ΔU=ΔW, minus conventional losses, the rate of isothermal heat absorption in the cooling plenum (ΔU) is controlled by the heat removal in the cooling plenum (see FIG. 3).

### Conditions Below Determine the Heat Removed:

1. The temperature delta (the approach) between the fluid temperatures in the working volume and the cooling plenum during the compression upstroke.
2. The rate of heat removal is governed by the quantity of mass pressed into the cooling plenum due to the volumetric change caused by the piston movement as controlled by the axial rotation (see FIG. 3).
3. The efficiency of the mass flow ⁱ through the three valves and residual engine plumbing.
4. The volumetric and surface area within the cooling plenum.
5. The brine coolant temperature monitoring.

The above first four conditions of heat removal are system design considerations. The fifth condition, the brine coolant temperature, will monitor, regulate, and control the heat absorption rate.

Interestingly, the helium or argon atoms that remain in the working chamber during the upstroke retain the same amount of heat. The only heat removal happens in the atoms that are pushed out of the working chamber into the cold plenum. That heat is contained within the mass that unidirectionally flows into the cold plenum. Any variance that occurs in the working fluid heat and temperature would depend on the impact of the varying pressure acting within both chambers. The heat absorption in the cold plenum determines the amount of mass flow into the cold plenum. During compression, the heat absorption will lag causing the temperature to rise above the brine temperature to be absorbed during the containment. Also, the temperature in the working chamber raises expediential with compression.

### The Math

Algebraic functions and their inversions are dependent on the inverting independent variables within an algebraic equation. Since the conservation of energy formula is

W=U−Q,

i.e.,

ΔpΔV=mRΔT−mCvΔT,

the adiabatic formula during the upstroke, each property is defined as a

W=U−Q inversion.

Let's look at how the adiabatic cycle occurs while the compression is applied, and heat is being removed. For instance, in the adiabatic formula, the upstroke and downstroke volume changes are the same. Also, the R and Cv factors are constant. The mass, temperature, pressure changes within the working chamber and the cold plenum depend on the amount of heat absorption in the cooling exchanger, i.e.,

pΔV=U−Q

and the volume relationships. The U is the internal energy in the system at BDC. Q is the amount of heat being removed during the upstroke.

Mathematically, the pressure-Volume or p-V graph defines a hyperbolic curve, with its x and y axes representing the pressure and volume relationship: (See the attachment)

$$\begin{matrix}y = A / x \\ y = pressure = p \\ x = Volume\end{matrix}$$

So, “A” is not a constant in the hyperbolic curve but a variable based on seven changing properties, i.e., two masses, two temperatures, two-volume relationships, and common variable pressure.

$$p = A / V ( Hyperbolic ) ,$$

In determining the pressure,

$${p}_{f} = ( {m}_{1} {T}_{1} R - {m}_{2} ( {T}_{1} - {T}_{2} ) Cv ) / ( {V}_{1} + {V}_{2} )$$

### So,

A=(m₁T₁R−m₂(T₁−T₂)Cv)

in the formula

W=U−Q=Internal Energy−Heat Removal by the cold plenum.

To determine the changing “A,” the mercurial numbers resulting from the seven changing properties−mass 1 in the working chamber (m₁), mass 2 in the cold plenum (m₂), temperature 1 in the working chamber (T₁), temperature 2 in the cold plenum (T₂), common pressure in the working chamber and cold plenum (p), the volume of the cold plenum (V₂), and the volume ratio of the expansion in the working chamber, varying the bolus volume in relationship to the expansion/compression volume (bolus volume and the expression/compression volume combined is V₁)—are determined and balanced. The formulas for each of the seven variables are as follows: (in bold)

That “A” value is

A=(m₁T₁R−m₂Cv(T₁−T₂)

as shown above. Within this, what is constant?

### The Constants are:

$$\begin{matrix}Cv = Specific Heat at constant volume = 3.1167 J / ° K - gm \\ {V}_{1} max = the maxium volume of the working chamber \\ {V}_{2} = Volume in the cold plenum = Constant \\ {R}_{m e t r i c} = 2.0734 J / ° K - gm is a constant . \\ Also , the total mass {m}_{total} = {m}_{1} + {m}_{2} is constant .\end{matrix}$$

So, in the bracketed

A=(m₁T₁R−m₂Cv(T₁−T₂),

only m₁, m₂, T₁ and T₂ individually are not constants. Of course, additionally, in the pressure formula

p_{f}=(n₁T₁R−n₂(T₁−T₂)Cv)/(V₁+V₂),

p, the pressure, is not a constant, and V₁ and V₂ must be adjusted to achieve optimum performance of the engine.

### Formulas:

$$\begin{matrix}{T}_{mixed} = [ {p}_{mixed} * ( {m}_{1} {T}_{1} / {p}_{1} + {m}_{2} {T}_{2} / {p}_{2} ) ] / {m}_{total} & ( mixed ) \\ {p}_{mixed} = ( {m}_{1} {T}_{1} + {m}_{2} {T}_{2} ) R / ( {V}_{1} + {V}_{2} ) & ( mixed )\end{matrix}$$

### Rotational Conditions

$$\begin{matrix}{P}_{f} = [ ( {m}_{1} {T}_{1} R + {m}_{2} ( {T}_{1} - {T}_{2} ) Cv ) ] / ( {V}_{1} + {V}_{2} ) \\ {T}_{1} = \frac{( p Δ V ) + {m}_{2} {T}_{2} Cv )}{( {m}_{1} R + {m}_{2} Cv )} \\ {T}_{2} = \frac{( p Δ V ) + {m}_{2} {T}_{1} Cv - {m}_{1} {T}_{1} R )}{{m}_{2} Cv} \\ {m}_{2} = \frac{2.52159 * {T}_{1} R ) - ( p Δ V )}{[ ( {T}_{1} - {T}_{2} ) Cv - {T}_{1} R ]} \\ {m}_{1} = {m}_{total} - {m}_{2} = 2.52 \; 159 - {m}_{2}\end{matrix}$$

mₜₒₜₐₗ is estimated at 2.52159 gm

We know that since the working fluid in the working chamber remains in that working chamber and, thus, is isolated with no heat removal, that working fluid is compressed adiabatically and predictably. The great unknown is the T₂ temperature in the cold plenum. However, this temperature can be controlled. Several adjustments can be made regarding the cold plenum conditions. The cooling exchanger (cold plenum) volume can be sized as is necessary to achieve optimum results. For one, the heat transfer surface area can be changed without changing the cold plenum volume. More surface area improves heat absorption. Reduction or increase of the volume will regulate the mass flow into the cooling exchanger. Also, the placement of the connection valve regulates the mass out of the engine. Of course, the parameters regulating the coolant passing through the cold plenum will have a major impact on the heat absorption and will finetune the end conditions thus affecting the heat absorption.

Since all variables within the cold plenum and working chamber are controllable, the study will require determining the optimum “sweet spot” conditions of the variables to optimize the efficiency and power out/input to achieve the optimum efficiency and power output. Since the engine will have a constant power output, in building the design, this study has sought out that “sweet spot” to achieve that optimum efficiency and power output.

Using the derivative formulas, all the real numbers for these seven variable unknowns are established on a database chart which can be demonstrated to any panel of experts. The database analysis confirms that the mass flow from the working chamber to the cold plenum is essentially unidirectional, meaning that the working fluid in the working chamber is essentially not being cooled, confirming that the compression upstroke is essentially adiabatic.

### Axioms to Aid in Designing the Johnston Power Converter:

1. The engine power output equals the difference between downstroke and upstroke power minus conventional losses.
2. To ensure that the mass flow is unidirectional, the low temperature in the cold plenum must be equal to or greater than the brine temperature.
3. The mass entering the engine must equal the mass that exits the engine.
4. Because the upstroke fluid flow into the cold plenum is unidirectional, no heat is removed from the working fluid remaining in the working chamber.
5. At the BDC cold plenum high-pressure release, the pressure will rise while the temperature drops.
6. At any pressure level during the upstroke, to be adiabatically equivalent, the internal energy removal in the cold plenum must equal the change in work in the working cylinder.
7. At any pressure level during the upstroke, the density in the cold plenum increases proportionally to the internal energy removal.
8. The cold plenum volume, the quantity of heat absorption, and the density ratio between the working chamber and the cold plenum regulate the quantity of bolus mass pumped back into the hot plenum.

### 2. Description of the Pneumatic and Piston Contact Valve Operation by Barry Johnston, Inventor

This disclosure minimizes moving parts and eliminates the need for an oil pan, flyrods, and journals on a drive shaft. The engine will have two opposing engines in a linear configuration with an oscillating generator in the center.

### The Six Steps of the Cycle

### Description of the Six Steps

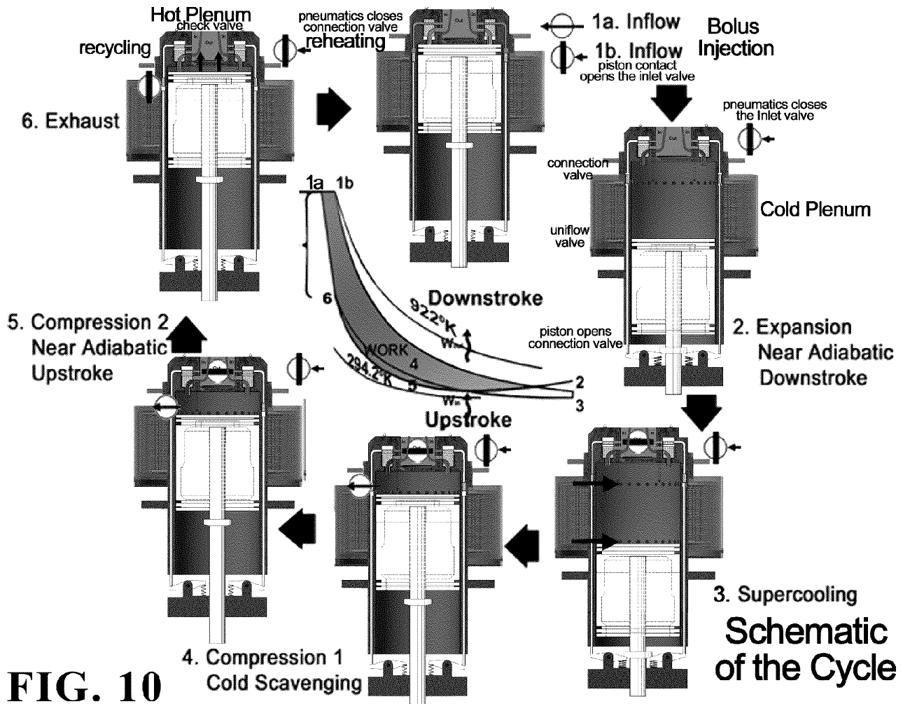

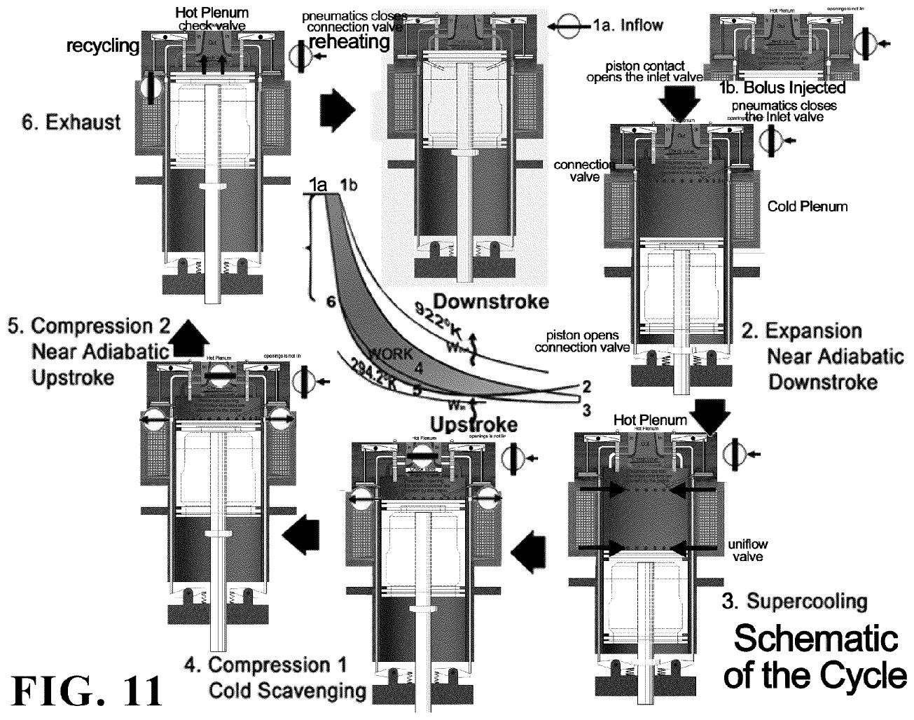

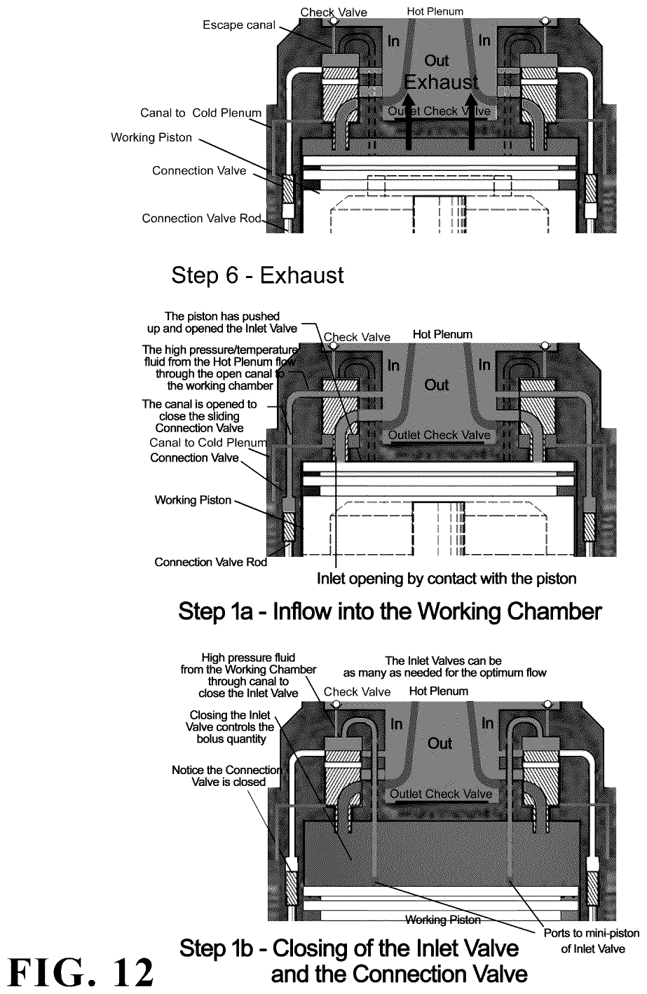

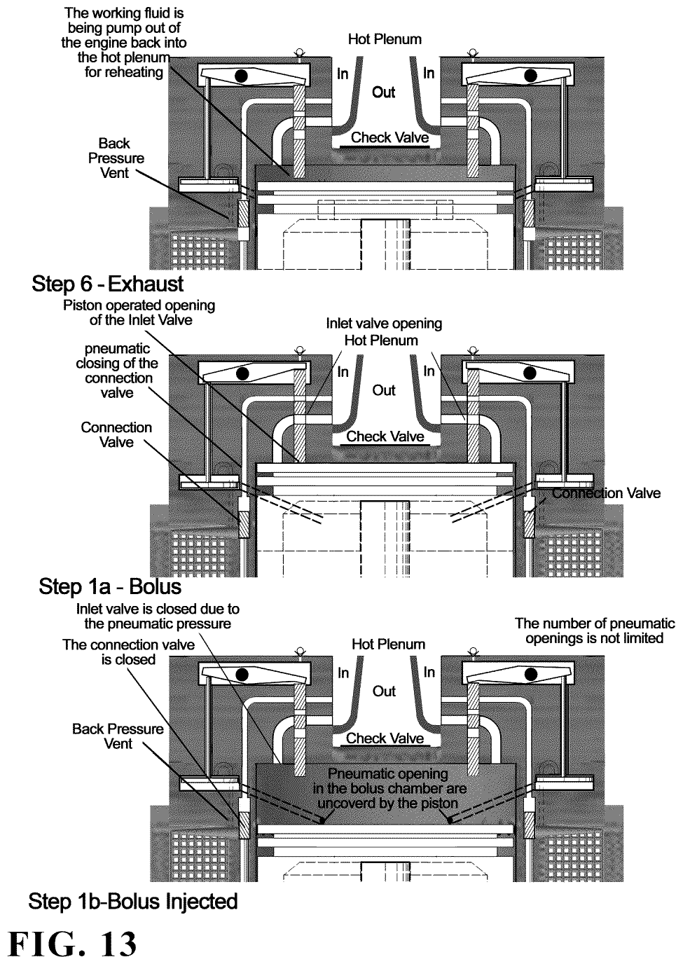

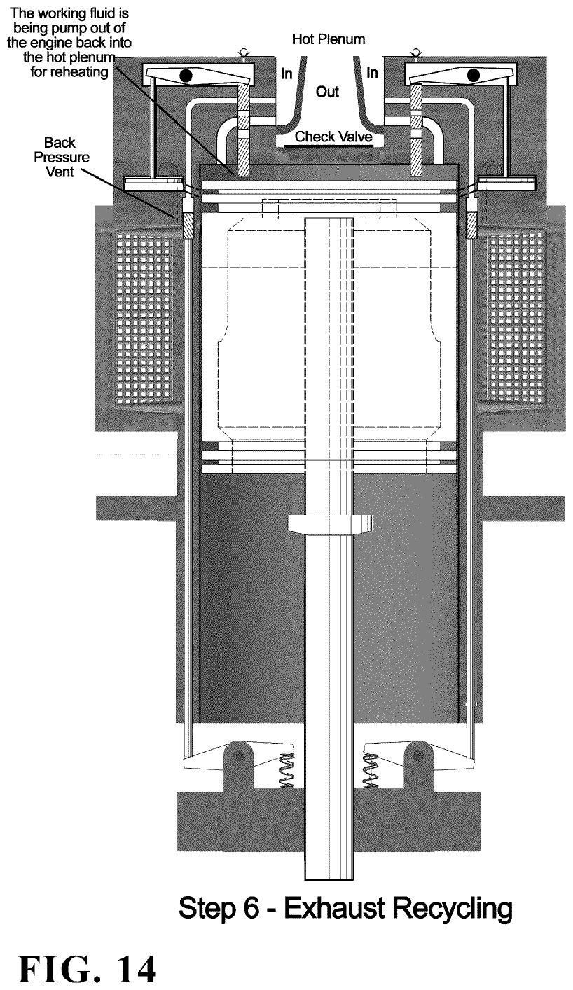

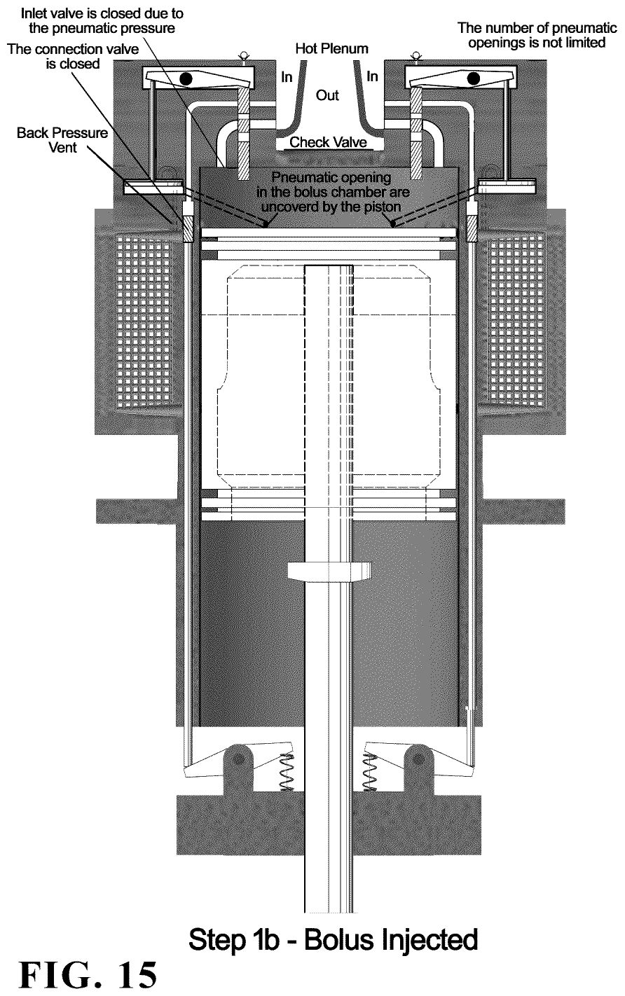

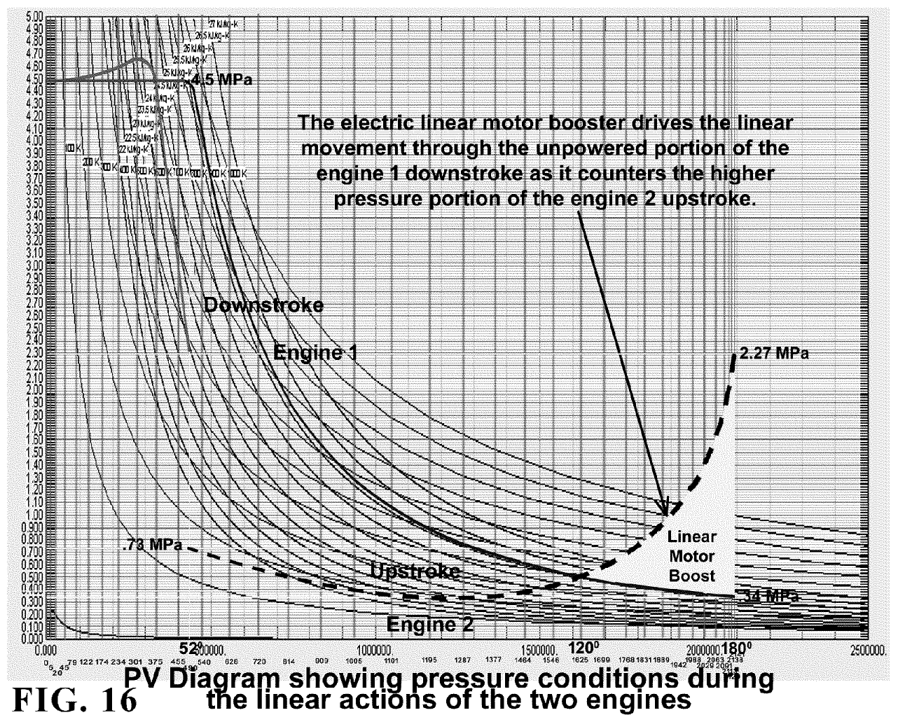

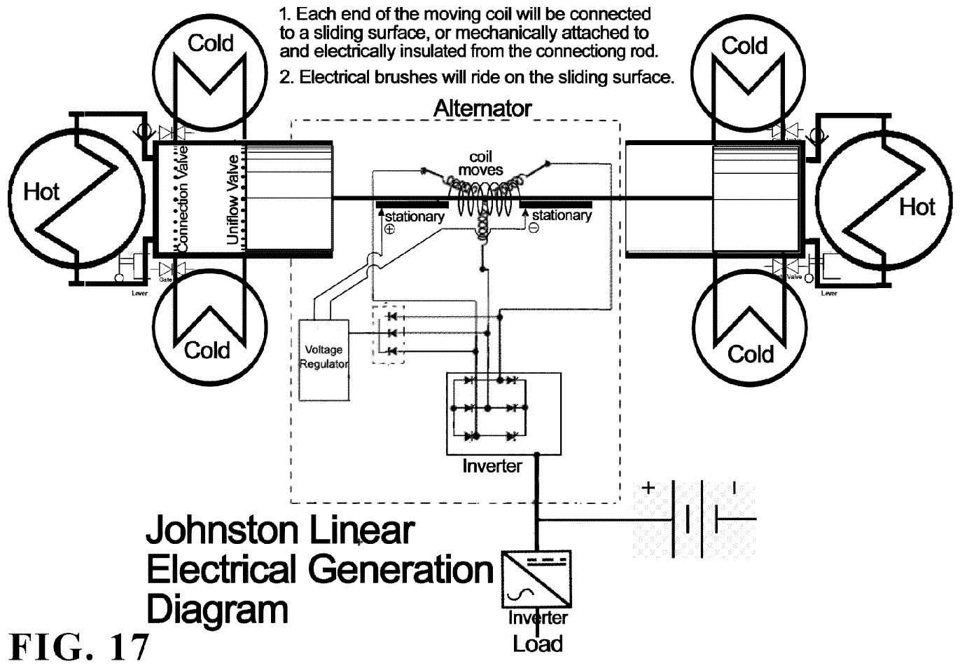

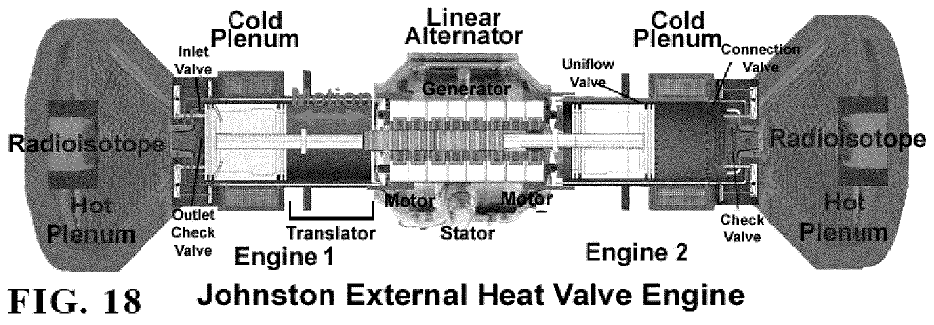

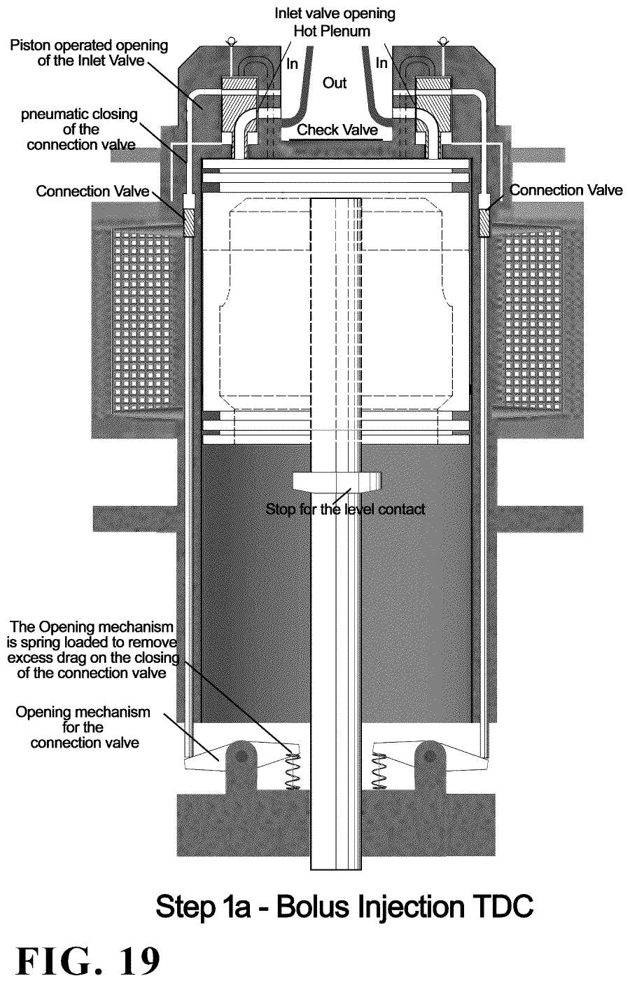

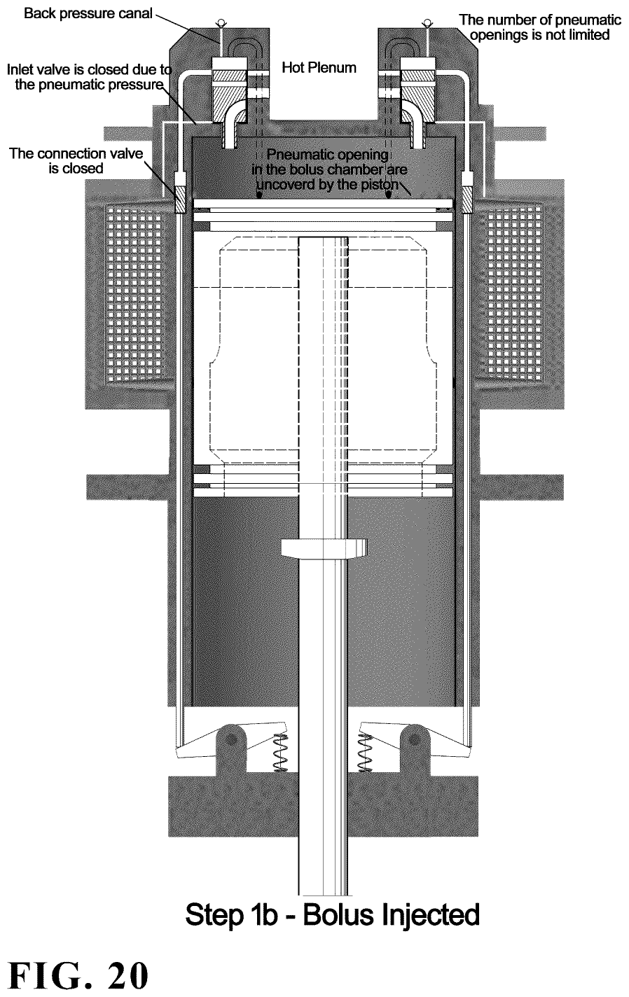

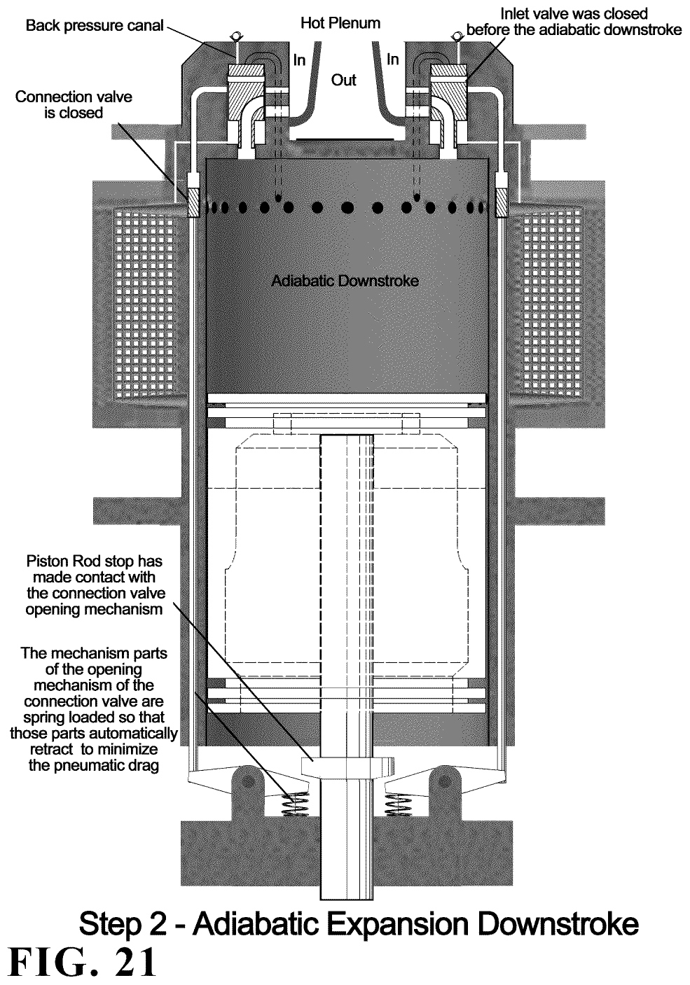

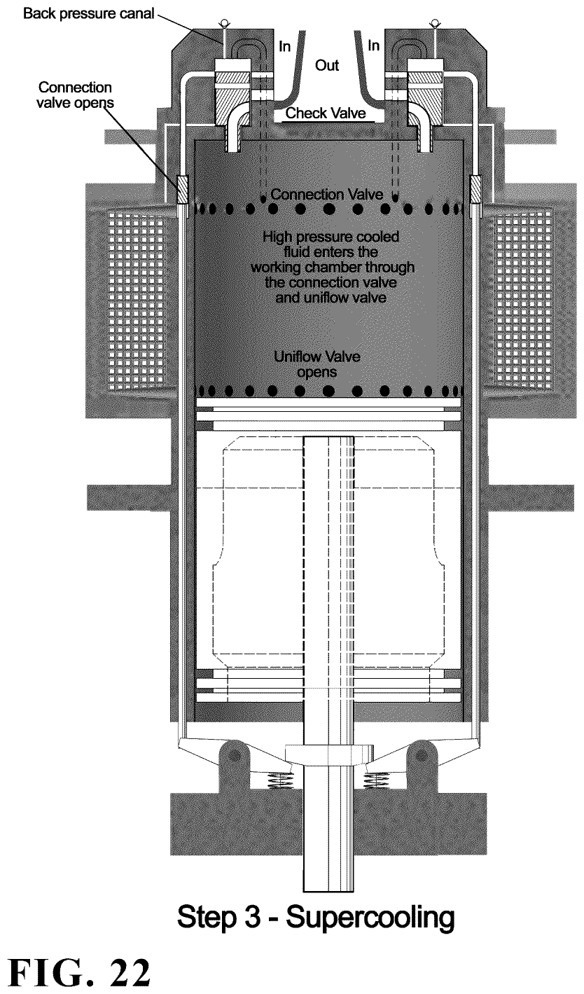

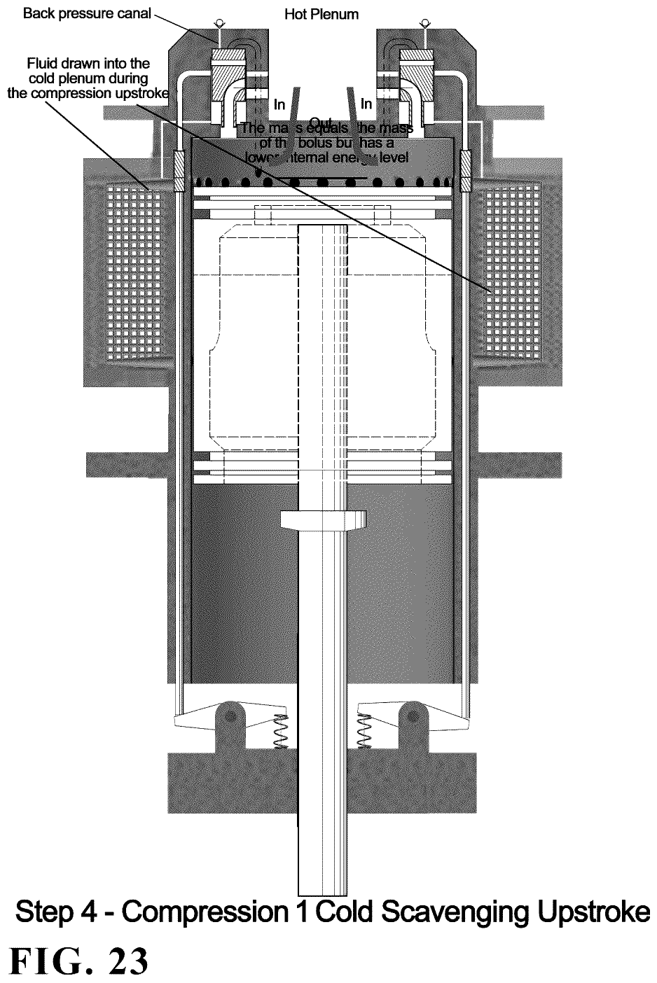

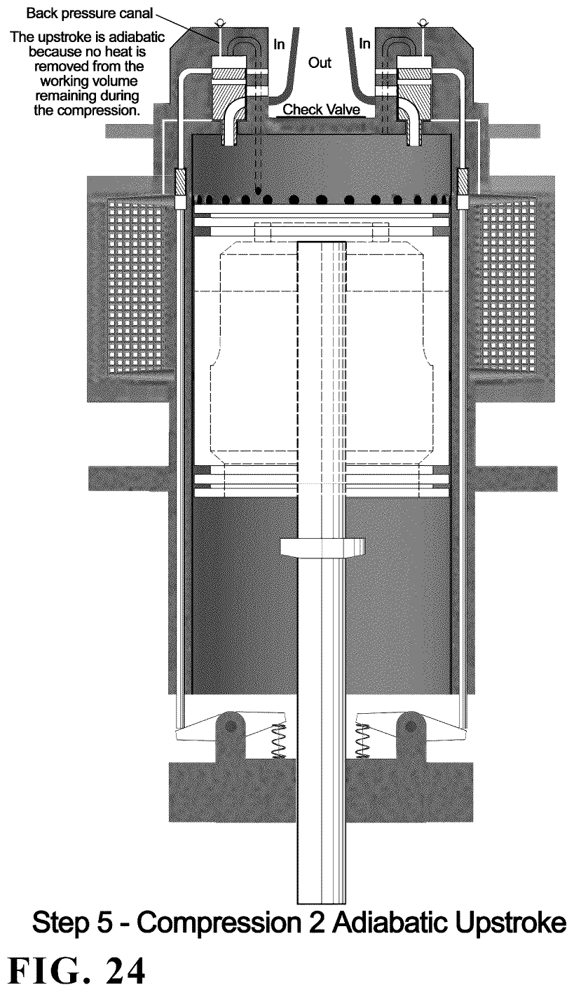

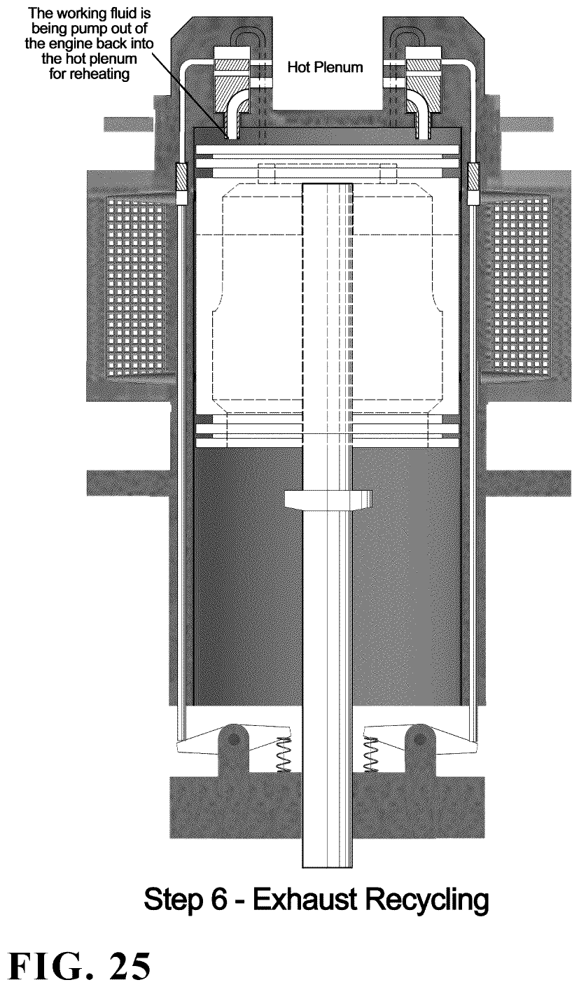

### The Following Explains the Pneumatic and Piston Contact Cycle Shown in FIG. 10.

1a. The Inflow into the Working Chamber.

The engine piston contacts and opens the inlet valve at Top Dead Center (TDC) which aligns the pneumatic valve openings between the hot plenum and working chamber so that the bolus is injected into the working chamber and to the connection valve surface face is pressurized, closing the connection valve between the working chamber and the cold plenum. Notice that the piston itself has already closed off the flow between the working cylinder and the cold plenum. The pneumatic closing of the connection valve seals the cold plenum for the remainder of the adiabatic expansion down stroke.

1b. Inlet Valve Closes

Notice that the walls of the working chamber have ports that become exposed during the downstroke. These ports are exposed right before the bolus volume is satisfied. The inlet valve ports access the pressurized fluid in the working chamber back into the back end of the inlet valve, pressurizing and forcing the inlet valve back into the closed position, shutting off the high-pressure flow. Said again, right before the bolus volume fills its portion of the working chamber, a pneumatic action closes the pneumatic inlet valve pushing the mechanism back into the TDC space in preparation for the next TDC inlet valve opening.

### 2. Expansion Near Adiabatic Downstroke

With the closing of the inlet valve, the injected bolus is isolated so its bolus can expand in isolation adiabatically during the down stroke.

### 3. Supercooling

The piston uncovers the uniflow valve at the Bottom Dead Center (BDC) position. During the previous cycle, fluid was pressed into the cold plenum, and under pressure, the fluid was isothermally cooling during the remainder of the cycle. At the BDC position, that pressurized fluid is released into the lower-pressure working chamber, cooling the expanded working fluid to a lower temperature while the pressure rises, lowering the internal energy significantly.

### 4. Compression 1-Cold Scavenging

As the piston starts its upstroke, the uniflow valve closes. However, the BDC contact with the piston rod stop mechanism opens the connection valve at the near TDC position. The process of removing heat from the cycle is repeated. A portion of the fluid is pressed into the cold plenum. The cold plenum is designed so that the heat removal keeps the temperature below the temperature in the working chamber so that the mass flow is always unidirectional into the cold plenum.

### 5. Compression 2-Near Adiabatic Upstroke

Since no heat is removed from the working fluid, the unidirectional flow of fluid into the cold plenum also ensures that the working fluid remaining in the working chamber is compressed adiabatically. The density ratio at the end of the adiabatic upstroke portion of the piston movement ensures that the correct portion remains in the working chamber (becoming a pump) for recycling.

6. Exhausting and Pumping back into the Hot Plenum

When the working piston reaches and closes the ports to the cold plenum, the flow out of the working chamber stops and the remaining volume becomes a pump volume that is pumped out of the former working chamber back into the hot plenum for recycling and reheating.

### The Proposed Innovation as Related to State-of-the-Art Stirlings

In the space race, China has already built and tested a radioisotope-driven linear converter in outer space. NASA's Stirling thermoelectric converter, being tested at the NASA Glenn Research Center, has been running continuously for 14 years, demonstrating its reliability due to minimal moving parts. Our proposed Johnston External Heat Valve Engine has four valves that monitor the internal fluid flow. Of these, the uniflow and check valves relate to the action of the piston or are fully automatic. the inlet poppet valve is operated pneumatically and by piston contact.

The connection valve is partially pneumatic and partially operated by the piston action. The grant would encourage exploring ways to make the connection valves fully pneumatic as if a jackhammer, valves with one or two moving parts. As proposed, the internal mechanisms monitor the working fluid to achieve an efficient adiabatic cycle. Our team would perfect the operation of the four valves. The efficiency and high power/weight density of the Johnston EHVE, configured as a linear generator (requiring no oil lubrication), surely meets the dynamic power converter offering objectives.

The Stirling free-piston was invented by William T. Beale of Ohio University in the early 1960s to overcome the difficulty of lubricating the crank mechanism. The Johnston EHVE, configured as a linear generator, of its four valves, two are self-acting, and one operates with the piston action. Only, the inlet poppet valves, feeding the initial bolus, operate independently.

EHVEs more closely approach an ideal adiabatic cycle. Stirling Engines (SE), the current state-of-the-art, configured as a free-piston, have a minimal number of moving parts. With EHVEs, the heat transfer into the engine occurs off the engine. With conventional SEs, the heat transfer occurs on the engine over the engine boundary. With EHVEs, to gain heat, the working gas is pumped out of the working volume into a high-temperature heater (Hot Plenum), and heat is rejected as it is pumped into a low-temperature cooler (Cold Plenum). The Johnston EHVE heat transfer processes are more nearly isotropic than the conventional SEs.

### The Linear Alternator

The alternator in a linear configuration can be programmed to function as both a motor and generator. Portions of the alternator action can instantaneously convert from serving as a generator to becoming a linear motor. This is controlled by the oscillating frequency to accelerate or brake the movement of the linear movement. These multi functions can all be incorporated into the large linear alternator at the center, serving as the main start-up motor and generator of the system. For the start-up, the main center alternator becomes a motor. After the start-up, the alternator becomes a generator. However within that oscillating movement, two smaller flanking units can be integrated to serve as mini-linear motors, interchangeably assisting, boosting, and completing the action of the latter third of the downstroke of its respective working cylinder.

Once the oscillation frequency of the Johnston engine linear movement is established, the internal loads between the engine and the motor/generator alternator are determined. However, approximately one-third of the latter portion of the downstroke (see the adjacent p-V graph) has less power than the pressure buildup accompanying upstroke. Thus, to complete the remaining portion of the downstroke, countering the tandem drag of the opposite engine upstroke, the engine needs a boost. The linear alternator will be internally regulated to brake or accelerate the linear forces as needed. The high-velocity motor/generator as shown below replaces the need for a typical flywheel, providing a constant steady circular flow of electrons throughout the alternator system. Flanking center alternators are motors, that act as boosters to complete the downstroke, aided by the below high-velocity motor/generator. Towards the end third of the downstroke of the piston, this linear motor kicks in to complete the stroke. The conventional rotary cycle with four cylinders, using a cam-operated poppet and the cam-operated connection valves, does not need a flywheel. The high-velocity rotary generator motor and alternator lighten the weight of a one or two-cylinder version of the Johnston engine.

### Part 3: Technical Objectives

[Physically, the Johnston power converter as a linear generator/alternator will jump-start to become fully operational. Mathematically, the formulas of the power converter are derived from the first law of thermodynamics, “conservation of energy,”

pΔV=mTR−mΔTCᵥ.

### The Most Efficient Engine Cycle is Adiabatic.

Adiabatic means the system is reversible, meaning that, during either the compression or expansion stroke, internal energy in the working chamber is fully converted to work (W) or vice versa. The change in internal energy occurs at BDC and TDC but not during the working stroke action. In fact, no heat is extracted from the Johnston power converter except through the isothermal cooling in the cold plenum, ΔQ_{cold plenum} and, no heat is added except through isothermal heating in the hot plenum, ΔQ_{hot plenum}. The downstroke has one level of energy, and the upstroke has a lower level. The difference yields optimum work output. Assuming the reviewers know this, there's no need for further explanation.

Clearly, the Johnston EHVE downstroke is adiabatic. The upstroke is the challenge. Adiabatic means no heat is extracted from the Johnston power converter module except through the isothermal cooling in the cold plenum, ΔQ_{cooling}, and no heat is added except through the isothermal heating in the hot plenum, ΔQ_{heating}, the cycle is equivalently adiabatic, i.e.,

−ΔU=ΔW minus conventional losses.

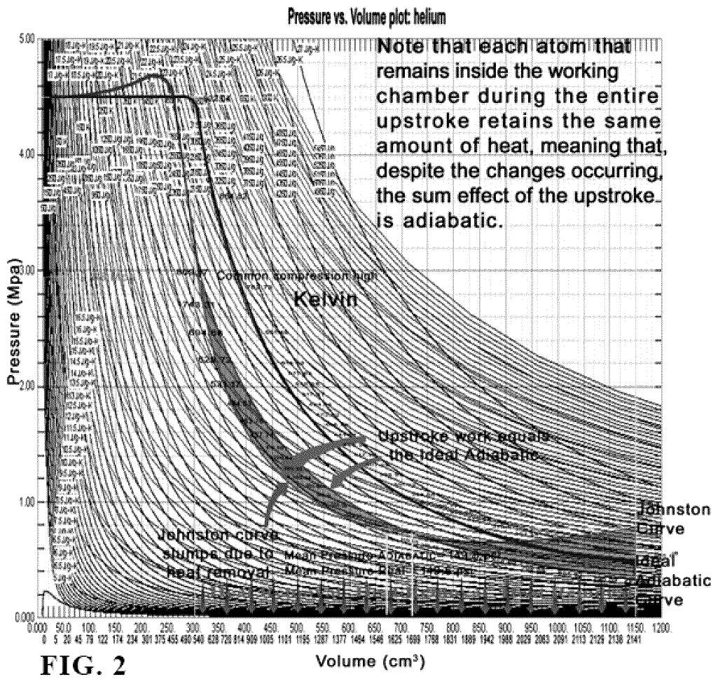

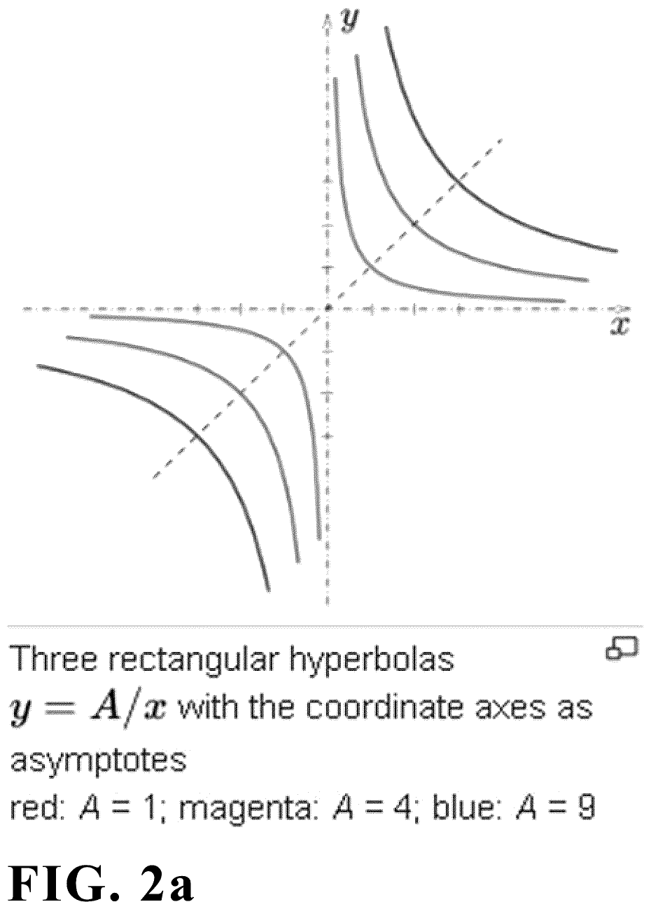

During the upstroke, the rate of isothermal heat absorption in the cold plenum (ΔU) alters the pressure (p) in the working chamber which controls the upstroke work (W) input (FIGS. 2 and 3). This heat extraction occurs 30 times/sec. Note that the combined opening area (A) connecting the cold plenum and working chamber (with 60 ports @0.75 cm diameter each) is equivalent to a 5.81 cm diameter round opening. Also, the BDC mixing occurs during ⅙^{th} of the cycle or (at 1800 RPMs) .00562 seconds.

### Heat Absorption in the Toroidal Cold Plenum

[After the cold plenum releases and mixes its pressurized fluid load into the working chamber at BDC, with the pressure rising and the temperature dropping the upstroke recompression of the working fluid is at a lower internal energy (U) level. During the upstroke, the rising pressure bust is progressively altered to a lower level as heat (Q) is removed by the cold plenum. This alters the work input (ΔpΔV) so as to match the adiabatic ideal.]

### The Power

The Johnston EHVE has exceptional power due to its effective method of heat removal under pressure in the cold plenum during the upstroke and during the remaining cycle. Since the working fluid remaining in the working chamber is isolated with no heat removal, that working fluid compresses nearly adiabatically. Our prepared database spreadsheet analyses show that heat removal in the cold plenum during the upstroke would be .162 kJ. The heat removal during the entire cycle is .658 kJ, which is equivalent to 1184 KJ/min or 19.7 kW. Finally, this is not to say no internal heat energy is removed during the upstroke, only that no heat energy is removed from the mass being recycled. All balances to achieve an adiabatic equivalence.]

### Optimizing the Heat Removal in the Cold Plenum

During the upstroke, the working chamber and cold plenum are interactive. To ensure an ideal adiabatic equivalence, heat removal in the Cold Plenum is unidirectional. Three upstroke conditions are required.
1) Achieve the lowest BDC sink temperature—The expansion ratio of the expansion downstroke at the end before the point of release determines the BDC high temperature. At the BDC point of release, the pressure rises while the temperature drops. The breadth of the temperatures at the BDC before and after the release defines the breadth of the heat removal. During the upstroke, the mass/heat flow into the cold plenum is unidirectional as long as the sink temperature remains below the working chamber temperature. The helium or argon atoms in the working chamber during the upstroke will retain their internal energy. The only heat energy removed occurs with the atoms unidirectionally pushed out of the working chamber into the cold plenum.
2) Achieve the correct mass flow and its internal energy recycling—Though the atoms are diversely dispersed through each upstroke, the Johnston EHVE's cycling mass at the near TDC recycling point (after the upstroke) must be equal to the mass of the initial bolas. The internal energy (U) retained in that mass upon recycling must match the adiabatic ideal (as if adiabatically compressed). To achieve this, the cold plenum will be sized so the density ratio between the two connected chambers-between the working chamber and the cold plenum—(at the point before the near TDC recycling) balances and regulates the correct quantity of mass and its internal energy being recycled. The correct density ratio between the two chambers ensures this correct equivalence. That correct quantity of internal energy remaining in the working chamber is recycled back into the hot plenum where its internal energy is replenished, roughly equaling the work output, ΔQ=—ΔW.
3) Achieve a matched balance between the real upstroke work and the ideal adiabatic upstroke work-During the upstroke, the mass/heat's unidirectional flow back into the cold plenum during the progressive pressure buildup, altering the pressure in the working chamber so its mean pressure equals the pressure of an ideal adiabatic upstroke. Thus, the heat absorption alters the upstroke work so that −ΔQ=ΔW.

### Fine Tuning the Physical Model

Within the constant power output of the Johnston power converter, all variables within the cold plenum and working chamber are controllable. Phase 1 research determines the physical characteristics necessary to achieve the optimum “sweet spot” condition providing optimum efficiency and power out/input.

The cold plenum volume will be sized to achieve the optimal internal heat absorption. The temperature T₂ in the cold plenum is regulated through several design adjustments. The heat transfer surface area can be adjusted without changing the cold plenum volume. A greater surface area will improve heat absorption. A reduction or increase of the volume will regulate the mass flow into the cold plenum. In addition, the placement of the connection valve can be slightly adjusted to regulate the quantity of mass being recycled.

In designing the Johnston EHVE, the bolus volume sets the expansion/compression ratio. Our prepared database spreadsheet analyzes, formulates, and confirms that, as long as the working chamber temperature remains above the sink temperature, the mass flow will be unidirectional. The analysis also confirms that no heat is removed from the working fluid mass remaining in the working chamber. The analysis formulates the approximate numerical values that balance the work adjustment against the heat removal. The grant challenge is to firm up these values and make necessary adjustments in the upstroke working volume (V₁) and cold plenum volume (V₂) conditions to achieve optimum adiabatic performance.

In seeking the “sweet spot,” the design proportions will be adjusted so the actual mean pressure aligns with the adiabatic ideal. Of course, operating at a high velocity, at 30 revolutions per second, there will be turbulence. But, as long as the BDC and upstroke temperatures are greater than the brine (sink) temperature, the quantum effect will ensure the mass is sucked into the cold plenum unidirectionally. The project's technical objectives are to complete component and system designs, build and exercise a thermodynamic model to confirm the system efficiency and project performance and prove the feasibility of a Johnston dynamic power converter for NASA unmanned robotic missions to the Moon and other solar system bodies. Since the Stirling free-piston has fewer moving parts, our focus is on the Johnston EHVE's four valves. Two—the uniflow and the check valves—are self-operating. The third, the connection valve, is pneumatically triggered by the piston movement. The fourth, the TDC bolus poppet valve, operates pneumatically, triggered by the TDC piston position.

### The Opening and Closing of the Inlet Valve

The Inlet Valve opens with the contact action of the Working Piston. The Inlet Valve closes with the uncovering of the ports on the wall of the Working Chamber right above the Connection Valve ports. The high pressure will close the Inlet Valve. The back pressure is addressed. For the opening, the piston contact will overcome the back pressure of the hot plenum (high). The canal behind the open position of the Inlet Valve releases the back pressure in the brine chamber or the Cold Plenum (lower).

In Step 1a, the Piston opens the Inlet Valve, allowing inflow from the Hot Plenum. The action also allows flow of the high pressure fluid to close the Connection Valve before that valve is exposed by the down movement of the Working Piston.

The inlet valve opens with the contact with the working piston, and closes with the exposure of the ports defining the bolus volume. The pressure is 4.5 MPa, which is 639 psi. So a 1 sq. in. piston face will have that 639 pd. of pressure closing the inlet valve. The connection valve opens with the BDC contact with the piston and closes pneumatically at TDC in tandem with the opening of the inlet valve.

The analysis will formulate the numerical values that balance the work against the heat removal. Necessary adjustments will be made in the upstroke working volume (V₁) and cold plenum volume (V₂) to achieve optimum adiabatic performance. Though operating at a high velocity and with turbulence, the quantum effect applies. The project technical objectives are to complete component and system designs, build and exercise a thermodynamic model to confirm the system efficiency and project performance, and prove the feasibility of the Johnston dynamic power converter for NASA unmanned robotic missions to the Moon and other solar system bodies. Our focus is to minimize the moving parts. Of the four valves, two—the uniflow and the check valves—are self-operating. The third and fourth, the connection valve and inlet valve, are pneumatically triggered by the piston movement.

One engine (as seen with the purple line of the adjacent p-V graph) has less power at the latter one-third of its downstroke than its opposing engine's upstroke (the red dashes). The established oscillation frequency of the two engines is the hertz output. The linear alternator will brake or accelerate as that hertz is decreased or increased. Plus, the high-velocity motor/generator (seen adjacent) provides a constant/steady loop current, replacing the need for a flywheel. If the hertz are raised, the internal force shifts from a generator to an engine. The downstroke is boosted by increasing the hertz input as a motor to overcome the above-described opposite engine resistance and as aided by the high-velocity motor/generator.]

The entirety of related U.S. Pat. No. 10,982,543, issued Apr. 20, 2021, titled “A NEAR-ADIABATIC ENGINE” is incorporated herein by reference.

### The Entireties of Related U.S. Patents Nos

U.S. Pat. No. 4,627,241
U.S. Pat. No. 4,698,973
U.S. Pat. No. 4,788,823
U.S. Pat. No. 4,805,410
U.S. Pat. No. 4,938,117
U.S. Pat. No. 4,947,731
U.S. Pat. No. 5,806,403
U.S. Pat. No. 5,926,643
U.S. Pat. No. 6,505,538
U.S. Pat. No. 7,866,953
U.S. Pat. No. 8,156,739
U.S. Pat. No. 10,451,000
   are also incorporated herein by reference.

1. A process, comprising:
an inflow stage at which an inlet valve is opens from a hot plenum, and injects a working volume with hot high-temperature/pressure working fluid, and then closes;
an expansion stage at which the hot working fluid expands as a piston moves down until reaching a bottom dead center (BDC):
a cold scavenge stage at which, as the piston approaches the BDC, uniflow ports at a bottom uncover, and timed valves at a top open, flooding the working fluid with cooled pressurized fluid from a cold plenum, and supercooling the expanded fluid into the working chamber wherein the fluid was prepared and cooled during a previous cycle;
a first compression stage at which the working volume fluid is compressed back into the cold plenum, where heat is removed, and upon being once recompressed, the timed valves close between the working volume and the cold plenum;
a second compression stage at which the fluid remaining in the working volume is compressed into a remaining upstroke volume before being pressed into the hot plenum, wherein a density ratio between the working volume and cold plenum governs a proportioning between the first compression stage and second compression stage; and
an exhaust stage at which the compressed fluid in the working volume is displaced by the piston motion through a one-way exhaust reed valve to the hot plenum, where it is reheated.
